(19) United States
(12) Patent Application Publication
(10) Pub. No.: US 2021/0116626 A1
(43) Pub. Date: Apr. 22, 2021

(54) BACKLIGHT MODULE AND DISPLAY DEVICE

(71) Applicant: WUHAN CHINA STAR OPTOELECTRONICS TECHNOLOGY CO., LTD., Wuhan, Hubei (CN)

(72) Inventors: Changchih Huang, Wuhan, Hubei (CN); Zhiyuan Hou, Wuhan, Hubei (CN)

(21) Appl. No.: 16/772,840

(22) PCT Filed: Nov. 11, 2019
(86) PCT No.: PCT/CN2019/117220

§ 371 Date: Jun. 15, 2020

(30) Foreign Application Priority Data
Sep. 10, 2019 (CN) 201910851707.6

(51) Int. Cl. F21V 8/00; G02F 1/1335; G02F 1/1368

(52) U.S. Cl. CPC G02B 6/0043; G02F 1/133514; G02F 1/1368; G02F 1/133528

(57) ABSTRACT

A backlight module and a display panel are provided. The backlight module includes a light guide plate, a plurality of nanostructures, a plurality of dot structures, and a light source. The light guide plate includes a plate body. The plate body includes glass. The plate body includes a first surface, a second surface, and a first side surface, and the first surface is opposite to the second surface. A plurality of nanostructures are disposed on the first surface of the plate body, and a plurality of dot structures are disposed on the second surface of the plate body. A light source is disposed on the first side surface of the plate body. The light guide plate of the backlight module has a plurality of nanostructures and a plurality of dot structures, which makes thickness of the display device to be thin and increases light penetrability to improve screen brightness.

### BACKGROUND OF INVENTION

### Field of Invention

The present invention relates to the field of display technologies, and more particularly, to a backlight module and a display device.

### Description of Prior Art

Liquid crystal display devices have a backlight module, and a light guide plate installed in the backlight module guides light from an edge of the devices to the user's sight. Generally, material of the light guide plate is mainly plastic, such as acrylic or polycarbonate, and the structure of the dot structures in the light guide plate destroys the total reflection of the light in one direction, changes light path, and allows the light to travel farther, thereby achieving a surface light source effect.

In order to reduce thickness of liquid crystal displays, it is necessary to further improve the material and structure of a light guide plate.

### SUMMARY OF INVENTION

A backlight module and a display panel are provided. The backlight module includes a light guide plate, a plurality of nanostructures, and a light source. The light guide plate includes a plate body, and material of the plate body includes glass. The plate body includes a first surface, a second surface, and a first side surface, the first surface is opposite to the second surface. A plurality of nanostructures are disposed on the first surface of the plate body, and a plurality of dot structures are disposed on the second surface of the plate body. A light source is disposed on the first side surface of the plate body.

In one embodiment, a thickness of the plate body ranges from 0.4 mm to 1 mm.

In one embodiment, the plate body includes one of a flat plate shape, a wedge shape, a T shape, and a combination thereof.

In one embodiment, a width of each of the plurality of nanostructures is less than 60 nm, and a distance between the nanostructures is less than 120 nm.

In one embodiment, material of the plurality of nanostructures includes one of aluminum, iron, copper, chromium, silver, and gold.

In one embodiment, a shape of each of the plurality of dot structure includes one of a circle, a square, a hexagon, a ellipse, and a polygon.

In one embodiment, a width of the plurality of dot structures ranges from 0.1 mm to 1 mm, and a distance between the dot structures ranges from 0.1 mm to 10 mm.

A display device includes a backlight module and a display panel disposed on the backlight module. The backlight module includes a light guide plate, a plurality of nanostructures, a plurality of dot structures, and a light source. The plate body includes a first surface, a second surface, and a first side surface. The first surface is opposite to the second surface. The first side surface is connected to the first surface and the second surface. The plurality of nanostructures are disposed on the first surface of the plate body. The plurality of dot structures are disposed on the second surface of the plate body. The light source is disposed on the first side surface of the plate body.

In one embodiment, a width of each of the plurality of nanostructures is less than 60 nm, and a distance between the nanostructures is less than 120 nm.

In one embodiment, a width of each of the plurality of dot structures ranges from 0.1 mm to 1 mm, and a distance between the dot structures ranges from 0.1 mm to 10 mm.

A display device includes a display panel and a backlight module. The display panel is disposed on the backlight module. The display panel includes a first substrate, a first polarizer, a thin film transistor array substrate, a liquid crystal layer, a color filter, a second polarizer, and a second substrate. The first polarizer and the second polarizer include a plurality of nanostructures. The backlight module includes a light guide plate, a plurality of dot structures, and a light source. The light guide plate includes a plate body. The plate body includes a first surface, a second surface, and a first side surface. The first surface is opposite to the second surface. The first side surface is connected to the first surface and the second surface, and material of the plate body includes glass. The plurality of dot structures are disposed on the second surface of the plate body. The light source is disposed on the first side surface of the plate body.

In one embodiment, the plurality of nanostructures include a plurality of wire grid patterns.

In one embodiment, a width between each of the wire grid patterns is less than 60 nm.

In one embodiment, a distance between each of the wire grid patterns is less than 120 nm.

In one embodiment, the plate body includes one of a flat plate shape, a wedge shape, a T shape, and a combination thereof.

In one embodiment, material of the plurality of nanostructures includes one of aluminum, iron, copper, chromium, silver, and gold.

In one embodiment, a shape of each of the plurality of dot structure includes one of a circle, a square, a hexagon, a ellipse, and a polygon.

In one embodiment, a width of each of the plurality of dot structures ranges from 0.1 mm to 1 mm, and a distance between the dot structures ranges from 0.1 mm to 10 mm.

Compared with the prior art, the light guide plate of the backlight module has a plurality of nanostructures and a plurality of dot structures, which makes the thickness of the display device to be thin, and increases the light penetrability to improve screen brightness.

### BRIEF DESCRIPTION OF DRAWINGS

FIG. 1 is a schematic view of a backlight module according to one embodiment of the present invention.

FIG. 2 is a schematic view of a quantum dot display device according to one embodiment of the present invention.

FIG. 3 is a schematic view of a quantum dot display device according to another embodiment of the present invention.

FIG. 4 is a schematic diagram of a liquid crystal display device according to another embodiment of the present invention.

### DETAILED DESCRIPTION OF PREFERRED EMBODIMENTS

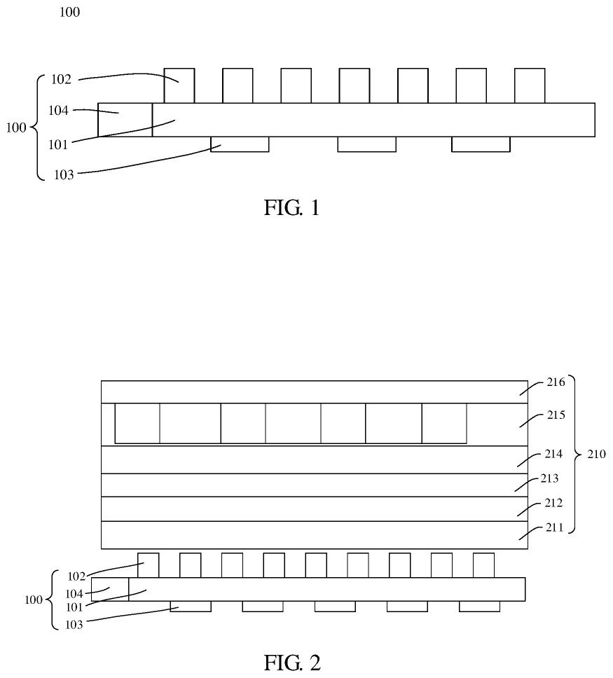

Referring to FIG. 1, the backlight module 100 according to one embodiment of the present invention includes a light guide plate 101, a plurality of nanostructures 102, a plurality of dot structures 103, and a light source 104. The light guide plate 101 includes a plate body, and material of the plate body includes alkali-free glass. Specifically, the plate body includes a first surface, a second surface, and a first side surface, and the first surface is opposite to the second surface. The first side surface is connected to the first surface and the second surface. A thickness of the plate body ranges from 0.4 mm to 1 mm, and plate body includes one of a flat plate shape, a wedge shape, a T shape, or a combination thereof. The plurality of nanostructures 102 are disposed on the first surface of the plate body, a width of each of the plurality of nanostructures 102 is less than 60 nm, and a distance between the nanostructures 102 is less than 120 nm. Preferably, material of the plurality of nanostructures 102 includes one of aluminum, iron, copper, chromium, silver, or gold. More preferably, the plurality of nanostructures 102 are wire grid polarizers. Specifically, a shape of each of the plurality of dot structures 103 includes one of a circle, a square, a hexagon, an ellipse, or a polygon, a width of each of the plurality of dot structures 103 ranges from 0.1 mm to 1 mm, and a distance between the dot structures 103 ranges from 0.1 mm to 10 mm. The light source 104 is disposed on the first side surface of the plate body. The light guide plate of the backlight module has a plurality of nanostructures and a plurality of dot structures, which makes the thickness of the display device to be thin, and increases the light penetrability to improve screen brightness.

Referring to FIG. 2, a quantum dot display device 200 according to another embodiment of the present invention is provided. The quantum dot display device 200 includes a backlight module 100 and a display panel 210 disposed on the backlight module 100. Specifically, display panel 210 includes a first glass substrate 211, a thin film transistor array substrate 212 disposed on the first glass substrate 211, a liquid crystal layer 213 disposed on the thin film transistor array substrate 212, a polarizer 214 disposed on the liquid crystal layer 213, a quantum dot color filter 215 disposed on the polarizer 214, and a second glass substrate 216 disposed on the quantum dot color filter 215. In addition, the backlight module 100 according to one embodiment of the present invention includes a light guide plate 101, a plurality of nanostructures 102, a plurality of dot structures 103, and a light source 104. The light guide plate 101 includes a plate body, and material of the plate body includes alkali-free glass. Furthermore, the plate body includes a first surface, a second surface, and a first side surface, and the first surface is opposite to the second surface. The first side surface is connected to the first surface and the second surface. A thickness of the plate body ranges from 0.4 mm to 1 mm, and plate body includes one of a flat plate shape, a wedge shape, a T shape, or a combination thereof. The plurality of nanostructures 102 are disposed on the first surface of the plate body, a width of each of the plurality of nanostructures 102 is less than 60 nm, and a distance between the nanostructures 102 is less than 120 nm. Preferably, material of the plurality of nanostructures 102 includes one of aluminum, iron, copper, chromium, silver, or gold. More preferably, the plurality of nanostructures 102 are wire grid polarizers. Specifically, a shape of each of the plurality of dot structure 103 includes one of a circle, a square, a hexagon, an ellipse, and a polygon, a width of each of the plurality of dot structures 103 ranges from 0.1 mm to 1 mm, and a distance between the plurality of dot structures 103 ranges from 0.1 mm to 10 mm. The light source 104 is disposed on the first side surface of the plate body. Preferably, the light source 104 is a light emitting diode.

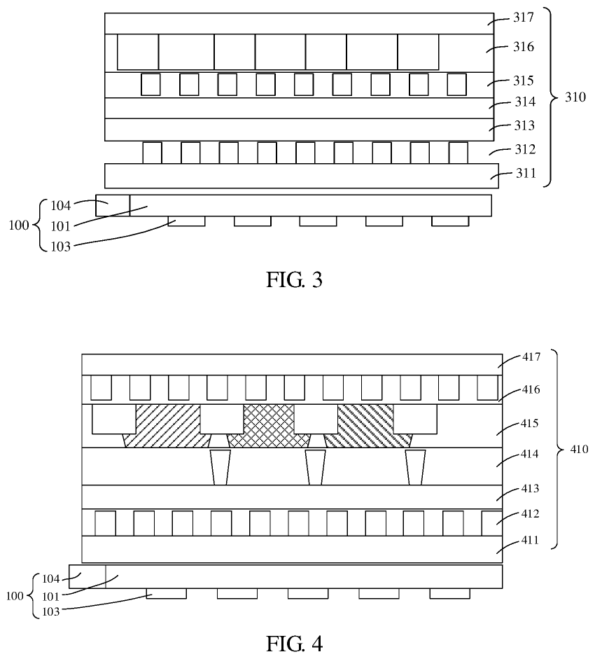

Referring to FIG. 3 a quantum dot display device 300 according to another embodiment of the present invention is provided. The quantum dot display device 300 includes a backlight module 100 and a display panel 310 disposed on the backlight module 100. Specifically, display panel 310 includes a first glass substrate 311, a plurality of wire grid polarizers 312 disposed on the first glass substrate 311, a thin film transistor array substrate 313 disposed on the plurality of wire grid polarizers 312, a liquid crystal layer 314 disposed on the thin film transistor array substrate 313, a polarizer 315 having a plurality of wire grid patterns disposed on the liquid crystal layer 314, a quantum dot color filter 316 disposed on the polarizer 315, and a second glass substrate 317 disposed on the quantum dot color filter 316. Furthermore, a width of each of the plurality of wire grid polarizers 312 is less than 60 nm, and a distance between each of the plurality of wire grid polarizers 312 is less than 120 nm. Similarly, a width of the wire grid patterns of the polarizer 315 is less than 60 nm, and a distance of each of the wire grid patterns is less than 120 nm. Preferably, material of the plurality of wire grid polarizers 312 includes one of aluminum, iron, copper, chromium, silver, or gold. In addition, the backlight module 100 includes a light guide plate 101, a plurality of dot structures 103, and a light source 104. The light guide plate 101 includes a plate body, and material of the plate body includes alkali-free glass. Specifically, the plate body includes a first surface, a second surface, and a first side surface, and the first surface is opposite to the second surface. The first side surface is connected to the first surface and the second surface. A thickness of the plate body ranges from 0.4 mm to 1 mm, and plate body includes one of a flat plate shape, a wedge shape, a T shape, or a combination thereof. The plurality of dot structures 103 are disposed on the second surface of the plate body. A shape of each of the plurality of dot structures 103 includes one of a circle, a square, a hexagon, an ellipse, or a polygon, a width of each of the plurality of dot structures 103 ranges from 0.1 mm to 1 mm, and a distance between the dot structures 103 ranges from 0.1 mm to 10 mm. The light source 104 is disposed on the first side surface of the plate body. Preferably, the light source 104 is a light emitting diode.

Referring to FIG. 4, a liquid crystal display device 400 according to another embodiment of the present invention is provided. The liquid crystal display device 400 includes a backlight module 100 and a display panel 410 disposed on the backlight module 100. Specifically, display panel 410 includes a first glass substrate 411, a first polarizer 412 having a plurality of wire grid patterns disposed on the first glass substrate 411, a thin film transistor array substrate 413 disposed on the first polarizer 412, a liquid crystal layer 414 disposed on the thin film transistor array substrate 413, a color filter 415 disposed on the liquid crystal layer 414, a second polarizer 416 having a plurality of wire grid patterns disposed on the color filter 415, and a second glass substrate 417 disposed on the second polarizer 416.

Furthermore, a width between each of the wire grid patterns of the first polarizer 412 is less than 60 nm, and a distance between each of the wire grid patterns of the first polarizer 412 is less than 120 nm. Similarly, a width between each of the wire grid patterns of the second polarizer 416 is less than 60 nm, and a distance between each of the wire grid patterns of the second polarizer 416 is less than 120 nm. Preferably, material of wire grid polarizers of the first polarizer 412 and the second polarizer 416 includes one of aluminum, iron, copper, chromium, silver, or gold. In addition, the backlight module 100 includes a light guide plate 101, a plurality of dot structures 103, and a light source 104. The light guide plate 101 includes a plate body, and material of the plate body includes alkali-free glass. Specifically, the plate body includes a first surface, a second surface, and a first side surface, and the first surface is opposite to the second surface. The first side surface is connected to the first surface and the second surface. A thickness of the plate body ranges from 0.4 mm to 1 mm, and the plate body includes one of a flat plate shape, a wedge shape, a T shape, or a combination thereof. The plurality of dot structures 103 are disposed on the second surface of the plate body. A shape of each of the plurality of dot structures 103 includes one of a circle, a square, a hexagon, an ellipse, or a polygon, a width of each of the plurality of dot structures 103 ranges from 0.1 mm to 1 mm, and a distance between the dot structures 103 ranges from 0.1 mm to 10 mm. The light source 104 is disposed on the first side surface of the plate body. Preferably, the light source 104 is a light emitting diode.

In the above, the present application has been described in the above preferred embodiments, but the preferred embodiments are not intended to limit the scope of the invention, and a person skilled in the art may make various modifications without departing from the spirit and scope of the application. The scope of the present application is determined by claims.

What is claimed is:

1. A backlight module, comprising:
a light guide plate, wherein the light guide plate comprises a plate body, the plate body comprises a first surface, a second surface, and a first side surface, the first surface is opposite to the second surface, the first side surface is connected to the first surface and the second surface, and material of the plate body comprises glass;
a plurality of nanostructures, wherein the plurality of nanostructures are disposed on the first surface of the plate body;
a plurality of dot structures, wherein the plurality of dot structures are disposed on the second surface of the plate body; and
a light source, wherein the light source is disposed on the first side surface of the plate body.

2. The backlight module according to claim 1, wherein a thickness of the plate body ranges from 0.4 mm to 1 mm.

3. The backlight module according to claim 1, wherein the plate body comprises one of a flat plate shape, a wedge shape, a T shape, or a combination thereof.

4. The backlight module according to claim 1, wherein a width of each of the plurality of nanostructures is less than 60 nm, and a distance between the nanostructures is less than 120 nm.

5. The backlight module according to claim 1, wherein material of the plurality of nanostructures comprises one of aluminum, iron, copper, chromium, silver, or gold.

6. The backlight module according to claim 1, wherein a shape of each of the plurality of dot structures comprises one of a circle, a square, a hexagon, an ellipse, or a polygon.

7. The backlight module according to claim 1, wherein a width of each of the plurality of dot structures ranges from 0.1 mm to 1 mm, and a distance between the plurality of dot structures ranges from 0.1 mm to 10 mm.

8. A display device, comprising:
a display panel; and
a backlight module, wherein the display panel is disposed on the backlight module;
wherein the backlight module comprises a light guide plate, wherein the light guide plate comprises a plate body, the plate body comprises a first surface, a second surface, and a first side surface, the first surface is opposite to the second surface, the first side surface is connected to the first surface and the second surface, and material of the plate body comprises glass;
a plurality of nanostructures, wherein the plurality of nanostructures are disposed on the first surface of the plate body;
a plurality of dot structures, wherein the plurality of dot structures are disposed on the second surface of the plate body; and
a light source, wherein the light source is disposed on the first side surface of the plate body.

9. The backlight module according to claim 8, wherein a width of each of the plurality of nanostructures is less than 60 nm, and a distance between the nanostructures is less than 120 nm.

10. The backlight module according to claim 8, wherein a width of each of the plurality of dot structures ranges from 0.1 mm to 1 mm, and a distance between the plurality of dot structures ranges from 0.1 mm to 10 mm.

11. A display device, comprising:
a display panel; and
a backlight module, wherein the display panel is disposed on the backlight module;
wherein the display panel comprises a first substrate, a first polarizer, a thin film transistor array substrate, a liquid crystal layer, a color filter, a second polarizer, and a second substrate, and the first polarizer and the second polarizer comprise a plurality of nanostructures; and
wherein the backlight module comprises:
a light guide plate, wherein the light guide plate comprises a plate body, the plate body comprises a first surface, a second surface, and a first side surface, the first surface is opposite to the second surface, the first side surface is connected to the first surface and the second surface, and material of the plate body comprises glass;
a plurality of nanostructures, wherein the plurality of nanostructures are disposed on the first surface of the plate body;
a plurality of dot structures, wherein the plurality of dot structures are disposed on the second surface of the plate body; and
a light source, wherein the light source is disposed on the first side surface of the plate body.

12. The display device according to claim 11, wherein the plurality of nanostructures comprise a plurality of wire grid patterns.

13. The display device according to claim 12, wherein a width between each of the wire grid patterns is less than 60 nm.

14. The display device according to claim 13, wherein a distance between each of the wire grid patterns is less than 120 nm.

15. The display device according to claim 11, wherein the plate body comprises one of a flat plate shape, a wedge shape, a T shape, or a combination thereof.

16. The display device according to claim 11, wherein material of the plurality of nanostructures comprises one of aluminum, iron, copper, chromium, silver, or gold.

17. The display device according to claim 11, wherein a shape of each of the plurality of dot structures comprises one of a circle, a square, a hexagon, an ellipse, or a polygon.

18. The display device according to claim 11, wherein a width of each of the plurality of dot structures ranges from 0.1 mm to 1 mm, and a distance between the plurality of dot structures ranges from 0.1 mm to 10 mm.
